(19) United States
(12) Patent Application Publication
(10) Pub. No.: US 2011/0279042 A1
(43) Pub. Date: Nov. 17, 2011

(54) LED LIGHTING SYSTEM WITH AUTO AND MANUAL DIMMING FUNCTIONS

(75) Inventor: Ming-Ho HUANG, Taipei Hsien (TW)

(73) Assignee: Chicony Power Technology Co., Ltd.

(21) Appl. No.: 12/778,217

(22) Filed: May 12, 2010

(51) Int. Cl. H05B 37/02

(52) U.S. Cl. 315/158

(57) ABSTRACT

An LED lighting system with auto and manual dimming functions includes an infrared remote control apparatus, a light sensing unit, an infrared receiving unit, a dimming controller, a switch driving circuit, and an LED lamp. The LED lighting system is integrated with the light sensing unit and the infrared receiving unit to provide auto and manual dimming functions to the LED lamp through the infrared remote control apparatus, thus providing optimum illuminating brightness of the LED lamp.

### BACKGROUND OF THE INVENTION

1. Field of the Invention

The present invention relates to a LED lighting system, and more particularly to a LED lighting system with auto and manual dimming functions.

2. Description of Prior Art

LEDs present many advantages including lower energy consumption, longer lifetime, and maintenance free. Early days, the LEDs were used to indication or advertisement applications. Nowadays, LEDs play a significant role in illumination, backlight, and display applications. The development trends of the LEDs will be low costs, high efficiency, high reliability, and high power in terms of the practicability of the LEDs.

Pulse width modulation (PWM) technology is used to control illuminating brightness of the LEDs. PWM technology uses a rectangular pulse wave whose pulse width is modulated to control the LED driving circuit, thus changing turn-on time of forward current through the LEDs to adjust illuminating brightness thereof. Accordingly, this will produce thousands of brightness levels to provide high definition performances with detailed brightness variations.

According to the different colors or the amount of the LED lamps, different voltage levels are provided to drive the LED lamps. If it is only to use a constant-voltage power supply to drive the different LED lamps, however, the inseries current-limiting resistors have to be employed, thus preventing the power supply outputting an over voltage to the LED lamps. However, this will produce power losses, and the power losses would be converted into thermal losses. In addition, the variation of resistor value could be influenced by turning on the lamps or the environmental thermal effect. Hence, the resistor value of the lamps tends to reduce with the higher temperature. At this time, the output current of the power supply would significantly exceed the rated current, thus reducing the lifetime of the LED lamps and driving the LED lamps excessively. Accordingly, a constant current control is an ideal method to drive the LEDs to avoid changing current through the LEDs according to the forward voltage, thus maintaining illuminating brightness of the LED lamps.

Infrared is widely used in applications of communication and remote control. Because the infrared remote control has advantages of reliable stability, lower costs, lower power consumption, some home electric appliances, such as televisions, recorders, projectors, audio equipment, air conditioners, and other small appliances, are controlled through the infrared remote control.

An ambient light sensor is a kind of light sensor for sensing ambient light intensity. The sensed light intensity is converted into electric signal to automatically adjust illuminating brightness of lamps according the sensed ambient light. Thus, the ALS offers human eye comfort and lower power consumption.

Nowadays, however, the ON and OFF are most commonly used for operating general residential lamps. Hence, illuminating brightness of the lamp is the same as long as the lamp is turned on (no matter whether it is dark or shining), so that the user can not adjust illuminating brightness of the lamp according to the ambient brightness. Thus, this will cause human eye discomfort and larger power consumption for long time using.

Accordingly, it is desirable to provide an LED light system with auto and manual dimming functions to integrate with a light sensing unit and an infrared receiving unit to provide auto and manual dimming functions to LED lamps.

### SUMMARY OF THE INVENTION

In order to achieve the above-mentioned objects, a LED lighting system with auto and manual dimming functions is disclosed. The LED lighting system includes an infrared remote control apparatus, a light sensing unit, an infrared receiving unit, a dimming controller, a switch driving circuit, and an LED lamp.

The infrared remote control apparatus produces an infrared control signal. The light sensing unit senses ambient brightness to produce an ambient light signal. The infrared receiving unit produces an infrared light signal. The dimming controller is electrically connected to the light sensing unit and the infrared receiving unit to produce a dimming control signal. The switch driving circuit is electrically connected to the dimming controller to receive the dimming control signal and produce a driving signal. The LED lamp is electrically connected to the switch driving circuit to receive the driving signal, thus providing a constant-current drive to control illuminating brightness of the LED lamp.

Therefore, the LED lighting system is integrated with the light sensing unit and the infrared receiving unit to provide auto and manual dimming functions to the LED lamp through the infrared remote control apparatus, thus providing optimum illuminating brightness of the LED lamp.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of a dimming control integrated module according to the present invention;

FIG. 2 is a circuit diagram of a LED lighting system; and

FIG. 3 is a circuit diagram of an infrared remote control apparatus.

### DETAILED DESCRIPTION OF THE INVENTION

Reference will now be made to the drawing figures to describe the present invention in detail.

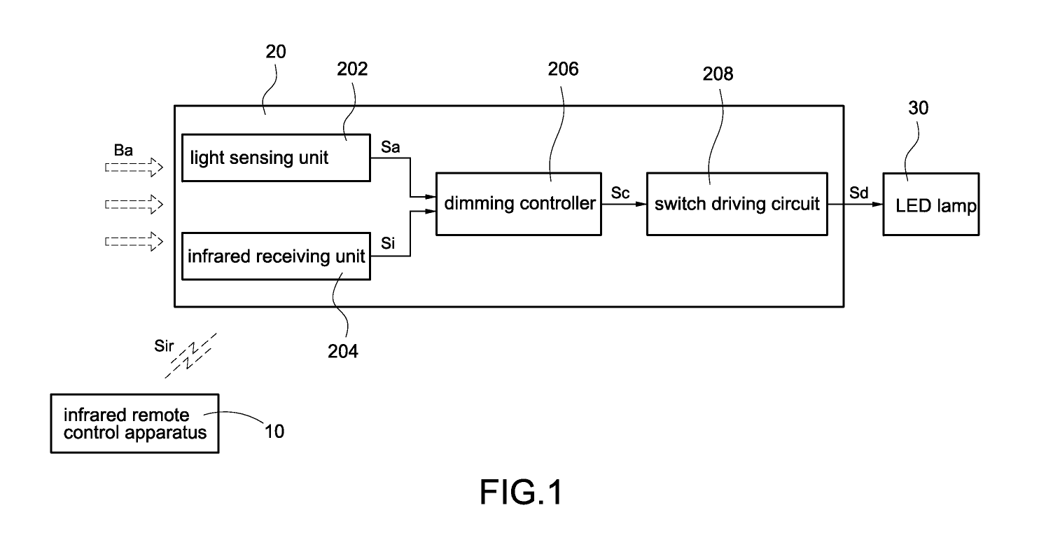

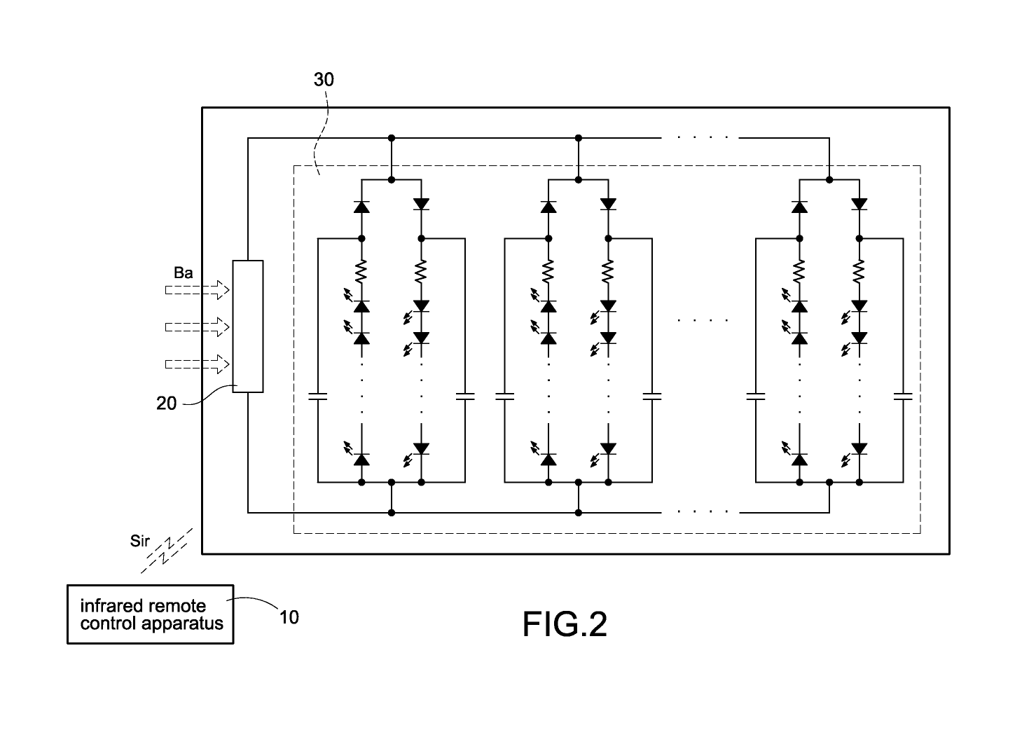

Reference is made to FIG. 1 and FIG. 2 which are a circuit diagram of a dimming control integrated module and a circuit diagram of a LED lighting system according to the present invention, respectively. The dimming control integrated module 20 includes a light sensing unit 202, an infrared receiving unit 204, a dimming controller 206, and a switch driving circuit 208. In addition, the LED lighting system further includes an infrared remote control apparatus 10 and an LED lamp 30. More particularly, the light sensing unit 202 is an ambient light sensor (ALS).

The infrared remote control apparatus 10 produces an infrared control signal Sir. The light sensing unit 202 senses an ambient brightness Ba to produce an ambient light signal Sa. The infrared receiving unit 204 produces an infrared light signal Si. The dimming controller 206 is electrically connected to the light sensing unit 202 and the infrared receiving unit 204 to produce a dimming control signal Sc to turn on and turn off the switch driving circuit 208. More particularly, a PWM control scheme is used to produce a digital pulse signal with a controllable duty cycle to produce the dimming control signal Sc. The switch driving circuit 208 is electrically connected to the dimming controller 206 to receive the dimming control signal Sc and produce a driving signal Sd. The LED lamp 30 is composed of a plurality of LED lamp strings (not labeled). Also, the LED lamp 30 is electrically connected to the switch driving circuit 208 to receive the driving signal Sd. Thus, a constant-current drive is provided through feeding back the output voltage to control the current of the LED lamp 30. Accordingly, only the duty cycle of the switch driving circuit 208 is varied (without changing the current through the LED lamp 30) to maintain the magnitude of the average current of the LED lamp 30 during every duty cycle.

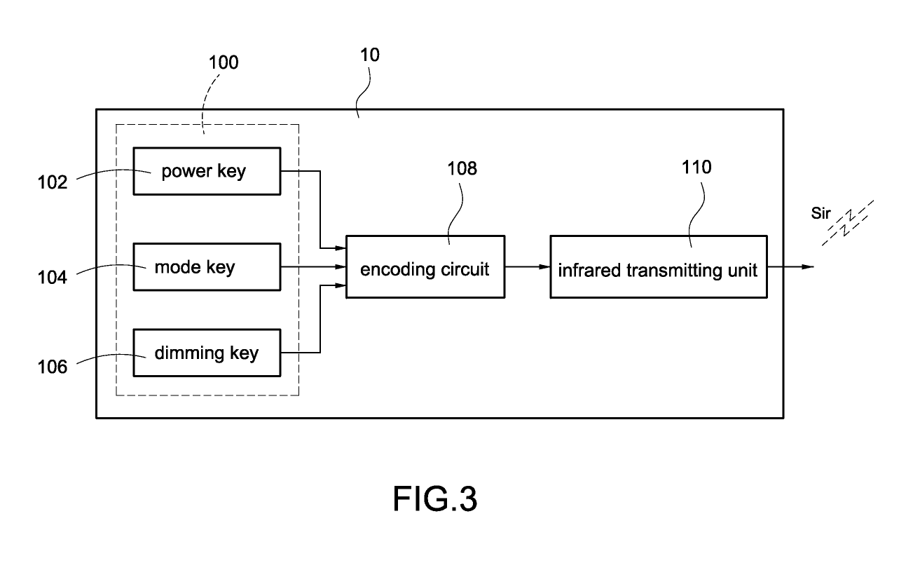

Reference is made to FIG. 3 which is a circuit diagram of an infrared remote control apparatus. The infrared remote control apparatus 10 includes a key unit 100, an encoding circuit 108, and an infrared transmitting unit 110. The key unit 100 includes a power key 102, a mode key 104, and a dimming key 106. The power key 102 is pressed to produce a power signal (not shown), the mode key 104 is pressed to produce a mode signal (not shown), and the dimming key 106 is pressed to produce a dimming signal (not shown). More particularly, the infrared transmitting unit 110 is an infrared LED.

The encoding circuit 108 is electrically connected to the key unit 100 to receive the power signal, the mode signal, and the dimming signal and encode these signals. The infrared transmitting unit 110 is electrically connected to the encoding circuit 108 to produce the infrared control signal Sir and transmit the infrared control signal Sir to the infrared receiving unit 204.

In addition, the infrared receiving unit 204 includes a decoding circuit (not shown) and a digital-to-analog converting circuit (not shown). The decoding circuit receives the infrared control signal Sir and decodes the infrared control signal Sir. The digital-to-analog converting circuit is electrically connected to the decoding circuit to convert the decoded digital infrared control signal into an analog infrared control signal, namely, the infrared light signal Si.

More particularly, the difference between the LED lamps and the general lamps is that the former are driven by the DC power supply and the latter are driven by the AC power supply. Hence, the AC-to-DC conversion apparatus is usually required for the use of driving the LED lamps. In this embodiment, the well-known AC-to-DC conversion apparatus is adapted; hence, the detail description of operating the AC-to-DC conversion apparatus is omitted here for conciseness.

The dimming controller 206 of the LED lighting system can be used to control the LED lamp 30 for any illuminating brightness in the brightness range. It is assumed that the infrared remote control apparatus 10 can be used to satisfy the control requirements of general residential lamps. In addition, illuminating brightness of the LED lamp 30 can be adjusted from 0% (dark) to 100% according to the actual demand. The operation procedure of controlling the LED lamp 30 is described as follows: First, the user can turn on the switch of the LED lamp 30 (such as the wall switch) or press the power key 102 of the infrared remote control apparatus 10. Afterward, the light sensing unit 202 of the LED lamp 30 senses the ambient brightness Ba in the present, thus automatically adjusting illuminating brightness of the LED lamp 30. More particularly, the sensing operation of the light sensing unit 202 is the initial operation of the LED lamp 30. When the user wants to adjust illuminating brightness of the LED lamp 30, the mode key 104 of the infrared remote control apparatus 10 is pressed to switch the auto sensing mode to the manual control mode of the of the infrared remote control apparatus 10. In the manual control mode, the user can press the dimming key 106 of the infrared remote control apparatus 10 to increase or decrease illuminating brightness of the LED lamp 30. In addition, the user can press the mode key 104 again to switch the manual control mode into the auto sensing mode of the light sensing unit 202. Repeatedly, the light sensing unit 202 senses the ambient brightness Ba to automatically adjust illuminating brightness of the LED lamp 30. Finally, the user can turn off the wall switch or press the power key 102 to finish operating the LED lamp 30.

Therefore, the LED lighting system is integrated with the light sensing unit 202 and the infrared receiving unit 204 to provide auto and manual dimming functions to the LED lamp 30 through the infrared remote control apparatus 10, thus providing optimum illuminating brightness of the LED lamp 30.

In conclusion, the present invention has following advantages:

Depending on actual requirements, users can manually remote control the infrared receiving unit 204 to flexibly adjust illuminating brightness of the LED lamp 30. In addition, the light sensing unit 202 is used to sense ambient brightness to automatically adjust illuminating brightness of the LED lamp 30. Especially, it is to achieve the purpose of saving energy when a small amount of illuminating brightness is required.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An LED lighting system with auto and manual dimming functions, comprising:
an infrared remote control apparatus producing an infrared control signal;
a light sensing unit sensing ambient brightness to produce an ambient light signal;
an infrared receiving unit producing an infrared light signal;
a dimming controller electrically connected to the light sensing unit and the infrared receiving unit to produce a dimming control signal;
a switch driving circuit electrically connected to the dimming controller to receive the dimming control signal and produce a driving signal; and
an LED lamp electrically connected to the switch driving circuit to receive the driving signal, thus providing a constant-current drive to control illuminating brightness of the LED lamp;
whereby the LED lighting system is integrated with the light sensing unit and the infrared receiving unit to provide auto and manual dimming functions to the LED lamp through the infrared remote control apparatus, thus providing optimum illuminating brightness of the LED lamp.

2. The LED lighting system in claim 1, wherein the infrared remote control apparatus comprises:
a key unit having:
a power key pressed to produce a power signal;
a mode key pressed to produce a mode signal; and
a dimming key pressed to produce a dimming signal;
an encoding circuit electrically connected to the key unit to receive the power signal, the mode signal, and the dimming signal and encode these signals; and
an infrared transmitting unit electrically connected to the encoding circuit to produce the infrared control signal and transmit the infrared control signal to the infrared receiving unit.

3. The LED lighting system in claim 1, wherein the infrared receiving unit comprises:
a decoding circuit receiving the infrared control signal and decoding the infrared control signal; and
a digital-to-analog converting circuit electrically connected to the decoding circuit to convert the decoded digital infrared control signal into an analog infrared control signal.

4. The LED lighting system in claim 1, wherein the LED lamp is composed of a plurality of LED lamp strings.

5. The LED lighting system in claim 1, wherein the light sensing unit is an ambient light sensor.

6. The LED lighting system in claim 2, wherein the infrared transmitting unit is an infrared LED.

7. The LED lighting system in claim 1, wherein the dimming controller produces a digital pulse signal with a controllable duty cycle through a PWM control scheme to turn on and turn off the switch driving circuit.
